(19) United States
(12) Patent Application Publication
(10) Pub. No.: US 2007/0206090 A1
(43) Pub. Date: Sep. 6, 2007

(54) Portable video system for two-way remote steadicam-operated interviewing

(76) Inventors: Toby Barraud, Brooklyn, NY (US); Stefan Springman, New York, NY (US)

Correspondence Address: HOFFMANN & BARON, LLP, 6900 JERICHO TURNPIKE, SYOSSET, NY, 11791, US

(21) Appl. No.: 11/711,352

(22) Filed: Feb. 27, 2007

Related U.S. Application Data
(60) Provisional application No. 60/779,592, filed on Mar. 6, 2006.

(51) Int. Cl. H04N 7/14

(52) U.S. Cl. 348/14.02

(57) ABSTRACT

A portable steadicam-operated two-way interviewing system provides direct eye to eye contact between host and subject even while the subject is in motion and in a remote location. The interviewing system includes a portable remote host station and a portable interviewing station that communicate via two-way wireless video and audio devices and directional antennae on both stations. The interviewing station includes a modem teleprompter-type arrangement, but with live video of the host displayed on the monitor. A stereo microphone picks up audio for recording with video onto a recording media. The host operates the remote host station while interviewing using a hand-carried telescoping staff with retractable tripod base for mounting the various components for portability.

### CROSS-REFERENCE TO RELATED APPLICATIONS

This application claims the benefit of U.S. Provisional Patent Application Ser. No. 60/779,592 filed on Mar. 6, 2006.

### FIELD OF THE INVENTION

The present invention relates generally to video filming systems and, more particularly, to a portable video two-way interviewing system.

### BACKGROUND OF THE INVENTION

Interviews for films or television are traditionally conducted with interviewer and interviewee in a static studio environment during which the various cameras film alternately one or both of the interviewer and interviewee. The speakers are naturally looking at each other, and not into the camera. Roaming interviews may, of course, also be conducted outside the studio, where the camera captures both interviewer and interviewee talking to each other while walking or while involved in other activities. Therefore, the audience perceives the interview in the impersonal third person, as an observer of a conversation between two people.

The concept of filming a subject who is looking directly into the camera while speaking, in order to more effectively engage the audience, was accomplished with the invention of the teleprompter in the 1950's. These early teleprompters, which were developed for use in the news casting industry, consisted of a simple monitor receiving an image of manually scrolled text. The monitor was placed as close as possible to the television camera lens through which the news caster was being filmed. Accordingly, the speaker could glance quickly back and forth between the monitor and the camera. However, the speaker could not look directly into the camera while reading from the monitor.

The modern teleprompter systems provide scripted text from a computer to a speaker in such a way that the speaker can read the text while looking directly into the camera. This is generally accomplished by providing a monitor at ninety degrees to the line of sight (or optical axis) between the video camera and the speaker's line of vision. A teleprompter screen which reflects the scrolled text into the speaker's line of vision is positioned in front of the camera. The screen is partially reflective and placed at an appropriate angle so that the scrolled text on the monitor is reflected into the line of vision of the speaker. Accordingly, the monitor, typically a simple monochrome device, is modified to reverse the horizontal scanning in order to compensate for the reflection of the text by the teleprompter screen. The screen has negligible effect on the transmission of the speaker's image through the screen and into the camera.

These teleprompter systems were designed for a very specific purpose, newscasting, with the end result to provide one-way transmission of video images of the speaker, rather than to facilitate an interview between two individuals. Adaptations of the teleprompter screen itself are also known for delivering a speech, for example, in television broadcasts of political speeches. In newscasting, it is also generally known to adapt such a teleprompter for use with a steadicam, so that the camera operator, equipped with the teleprompter, can follow a newscaster into the field.

Various modifications of the one-way video transmission teleprompter system are known for making news reporting and telecasting in the field more feasible, such as replacing the teleprompter screen and monitor arrangement with a crystal panel positioned above a news-gathering lens, as disclosed in U.S. Pat. No. 5,790,194 to Shimamura.

During the 1990's, a film producer, Errol Morris, modified a standard teleprompter for use in conducting interviews by substituting the computer with a video camera for providing live feed to the monitor. The system was dubbed “The Interratron.” The Interratron consists of two such modified teleprompters that allow the subject to look directly into the camera filming him or her while maintaining eye contact with an interviewer using the same system via the respective monitors. Therefore, live two-way video/audio transmission is obtained between interviewer and subject while maintaining direct eye contact between them. In this way, the interviewee, who is being filmed for broadcast, appears to address the audience directly during an interview, as described, for example, in an article posted on the Internet, at http://www.sensesofcinema.com/contents/cteq/01/13/stairway.html. The Interratron is known to have been used for the production of a series of documentaries in the 1990's during which sit-down interviews were obtained, both in studio and in the field.

Video-conferencing systems are also known which provide two-way audio/video transmission, and which generally provide the speaker with a teleprompter system so that it appears to the remote audience that the speaker is looking directly at them. U.S. Pat. No. 5,438,357 to McNelley provides a teleconferencing system that allows for eye contact between conferees by providing a terminal for each conferee with a monitor for receiving and viewing the image of a remote conferee, and a camera positioned above the monitor for transmission of the image to a second conferee. Because the conferees are not looking directly into the camera which captures their image, the appearance of eye contact is only achieved after image manipulation. Similarly, U.S. Pat. No. 5,675,376 to Andersson, et al. discloses a method of simulating eye contact for use in teleconferencing using image manipulation techniques.

Other teleconferencing systems, such as disclosed in U.S. Pat. No. 5,359,362 to Lewis et al., use two symmetrically opposed cameras from which a virtual image of the conferee apparently looking directly into the camera can be generated.

Both the video-conferencing systems and Mr. Morris' interviewing system, however, are static systems and not mobile or portable. The teleconferencing systems can only be used with conferees who are confined to a terminal, or at least to a confined area within a room. Video-conferencing with eye-contact between participants who are mobile and outside a controlled environment such as a studio is not known.

Similarly, Mr. Morris' system is only known for use in sit-down interviews, using standard video/audio cable hookups between the two teleprompters. Though the system is transportable to the field, it is not known to be mobile and portable (able to be hand-carried during operation) for interviewing a subject on the move.

U.S. Pat. No. 5,550,754 to McNelley, et al. discloses a combination portable recording video camera and video-conferencing terminal. In this system, a video camera and lens may be adjusted for use by the operator as a video conferencing terminal. The device may include a prompter type arrangement to allow the speaker to look directly into the camera when used in the video conferencing mode. When teleconferencing for eye-to-eye contact, however, the device is set up on a tabletop (see FIG. 20, e.g.) and is not portable or mobile. When the device is adapted for use as a portable videocamera, the teleprompter feature is not available.

U.S. Patent Publication No. 2003/0231238 A1 by Chew, et al. discloses a two-way video/audio transmission system for communication between a fixed unit and a mobile unit. The system uses satellite transmission in combination with local terrestrial communication infrastructure to communicate between the two units. One aspect of the invention includes a portable device with a monitor and camera that can be worn by a canine, for example, and which is in wireless communication with a teleconferencing apparatus set up in a mobile unit. The mobile unit is transported on a truck to a particular location. Once the canine reaches a victim, the wireless portable camera and display unit (a handheld PC with an omnidirectional antenna (see FIG. 4)), is used by the victim to report back to the mobile unit. The mobile unit, in turn, is connected by satellite to remote locations.

The mobile unit of the Chew, et al. publication does not disclose eye-to-eye contact between users at the two remote units. In addition, the Chew et al. publication does not disclose that the units are able to be hand-carried (portable) during operation.

There is a need, therefore, for a portable two-way interviewing system that provides direct eye-to-eye contact between interviewer and subject (i.e., interviewee) even while the subject is in motion and in a remote location.

### SUMMARY OF THE INVENTION

The present invention, which addresses the needs of the prior art, relates to a portable steadicam-operated two-way interviewing system that provides direct eye to eye contact between interviewer/host and interviewee/subject even while the subject is in motion.

The interviewing system includes a portable remote host station and a portable interviewing station that communicate via two-way wireless video and audio transmission. The interviewing station is operated by a third-party operator filming the subject of the interview, using a portable camera-stabilizing device, such as a STEADICAM® device.

At the interviewing station, video images of the host's face are preferably reflected by a partially reflective screen from a local monitor into the interviewee's line of vision. Behind the screen on which the host's face is viewed is a camera for capturing the subject's face as he speaks directly to the screen and thus the camera. Therefore, the subject, who may be in motion during the interview, looks directly into the camera while interacting with the interviewer's image.

The portable remote host system is operated by the host while conducting the interview, and provides the host with live video/audio of the interviewee, from the camera on the interviewing station. A compact camera/monitor arrangement, a telescoping pole, and the use of directional antennae mounted to the portable remote host system to permit two-way wireless transmission, allow the host to hand-carry the remote host system as necessary to maintain good video reception at all times. Simultaneously, the compact camera and monitor are arranged to allow the host to make eye to eye contact with the subject's face on the compact monitor, while appearing to look directly into the compact camera which sends the host's images to the subject's monitor. Consequently, a unique personalized format is provided for conducting a remote interview of a mobile subject in the field as opposed to in a studio or in a restrictive “sit-down” interview.

In particular, a portable steadicam-operated two-way interviewing system includes a portable interviewing station operated by a third party filming a subject/interviewee, and a portable remote host station for capturing and transmitting video and audio of a remote interviewer/host to the portable interviewing station.

The interviewing station includes wireless video devices and wireless audio devices configured to wirelessly transmit live, locally obtained video and audio of an interviewee to the remote host apparatus. Simultaneously, video and audio devices are included to wirelessly receive live video and audio of the interviewer from the remote host station. A directional antenna is included on the interviewing station for wirelessly receiving video from the remote host station. An omnidirectional antenna transmits the video of the subject to the host station.

The interviewing station further includes a video capture and display unit, which includes a video camera and a video monitor. The camera captures the locally obtained video of the interviewee for transmitting to the remote host station's monitor. The video monitor displays the received video and audio of a remote interviewer to an interviewee. The video monitor and camera are configured and arranged in the video capture and display unit to allow an interviewee looking directly into the video camera to maintain eye to eye contact with an image of a remote interviewer displayed on the video monitor.

Preferably, the video capture and display unit also includes a partially reflective screen. A surface of the monitor is preferably positioned parallel to the optical axis of the camera. The screen is positioned in front of the camera at a forty-five degree angle to the optical axis. The screen, monitor and camera on the interviewing station are relatively positioned so that the image from the monitor is partially reflected into the subject's line of vision by the screen. Accordingly, an interviewee looking directly into the video camera maintains eye to eye contact with an image of the remote interviewer displayed on the video monitor.

Preferably, a recording device is also included for recording the video and audio of the interviewee from the camera. A microphone and mixer are also provided for obtaining two-channel audio of the interviewee and inputting the mixed audio signal to the camera.

The interviewing system further includes a camera stabilizing system for dampening vibrations caused by motion of the video camera and thereby minimizing image degradation. The video capture and display unit, the wireless video/audio transmitter/receiver device, and the antennae, along with supportive electronics, such as battery packs, are operatively mounted on the camera stabilizing system.

The remote host station includes a wireless audio receiver and a wireless audio transmitter device, a wireless video transmitter and a wireless receiver device, and a directional transmitting antennae and a directional receiving device, which are configured to wirelessly transmit audio and video of an interviewer to the interviewing apparatus and to wirelessly receive the locally obtained video and audio of an interviewee from the interviewing station.

Preferably, separations between the portable remote host station and the interviewing station of at least thirty (30) feet are possible during operation.

The remote host station also includes a compact monitor and video capture unit, which includes a compact video camera configured to capture video of an interviewer for transmitting to the interviewing station. The remote host station also includes a compact monitor to display the received video and audio of the interviewee. The compact monitor and compact video camera are configured and aligned to allow an interviewer looking directly into the compact video camera to maintain eye to eye contact with an image of an interviewee displayed on the compact monitor.

The remote host station also includes a portable mounting staff which can be hand-carried by the host, and can also be set down on a retractable tripod base. The compact video camera, compact monitor, and the various wireless video devices including the directional antennae, and the wireless audio transmitting device are operatively mounted on the portable mounting staff. Preferably, the wireless audio receiving device includes earphones worn by the host to hear the interviewee's voice.

As a result, the present invention provides a portable steadicam-operated two-way interviewing system that provides direct eye to eye contact between interviewer (host) and interviewee (subject) even while the subject is in motion and in a remote location.

### BRIEF DESCRIPTION OF THE DRAWINGS

FIG. 1 is a system block diagram of a portable video system for two-way remote steadicam-operated interviewing formed in accordance with the present invention, including a portable remote host station and a portable interviewing system.

FIG. 2 is a perspective drawing of a telescoping mounting device, or staff, included in the remote host interviewing station.

FIG. 3 is a perspective drawing of the staff of FIG. 2 in a closed position.

FIG. 4 is a schematic representation of a preferred embodiment of the remote host station.

FIG. 5 is a perspective representation of video processing apparatus, for mounting on the staff shown in FIG. 4.

FIG. 6 is a perspective representation of the compact monitor and video capture unit shown in FIG. 4, showing placement of supporting electrical components on a mounting stage.

FIG. 7 is a schematic representation of an embodiment of the portable interviewing station for mounting to an arm of a STEADICAM® device.

FIG. 8 is a photographic representation of the portable interviewing station of FIG. 7.

FIG. 9 is a perspective representation of an embodiment of a video capture and display unit for the interviewing station of FIG. 7.

### DETAILED DESCRIPTION OF THE INVENTION

The present invention provides a portable steadicam-operated two-way interviewing system that provides direct eye contact between interviewer and subject at all times during the interview. The subject may be in motion and in a remote location.

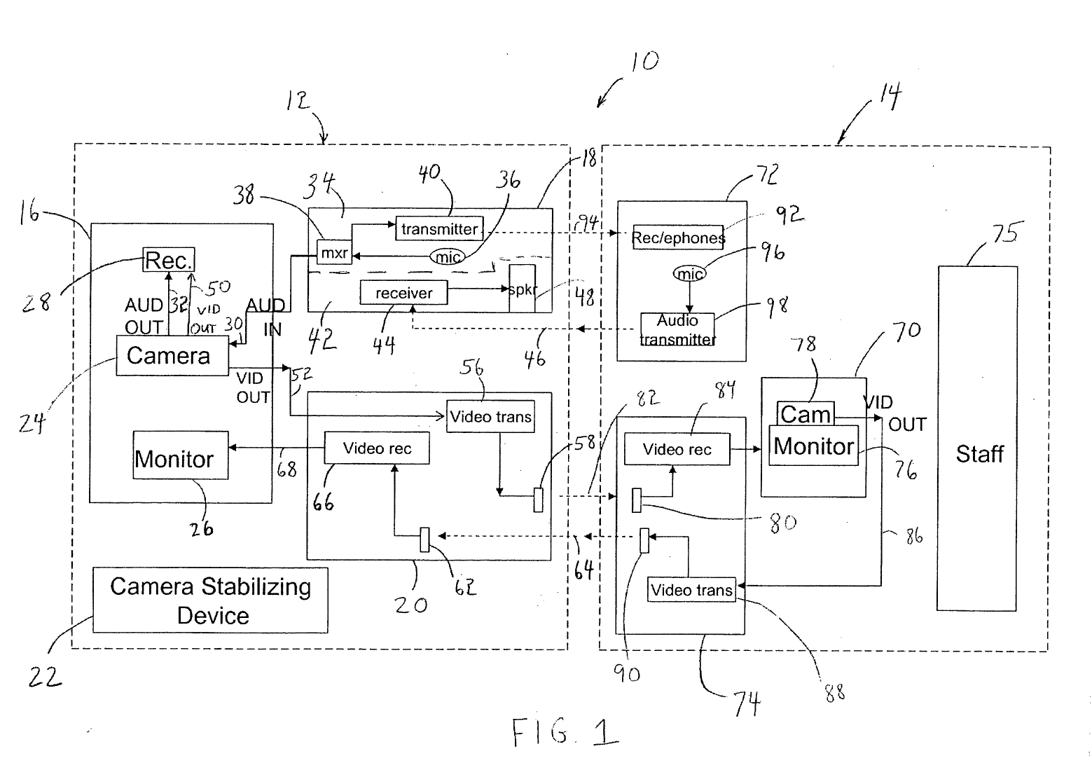

Referring to FIG. 1, an embodiment of the system 10 of the present invention includes a portable interviewing station 12 and a portable remote host station 14 which communicate with each other via two-way wireless video and audio. The interviewing station 12 is operated by a third party camera operator who films the interviewee, and the remote host station 14 is operated by an interviewer or host while conducting the interview. Both the interviewing station 12 and the remote host station 14 are portable, and able to be moved around during the interview by the camera operator and host, respectively, in order to follow an actively moving interviewee/subject. Portability of the system 10 is unencumbered by video and power cable, and all elements necessary for conducting and recording the interview are mounted to the portable stations. In addition, a remote interview may be conducted with interviewer and subject located over thirty feet apart, while simultaneously maintaining eye to eye contact with each other during the interview.

Referring to FIG. 1, the interviewing station 12 filming the subject includes a video capture and display unit 16, two-way wireless sound processing apparatus 18, and two-way wireless video processing apparatus 20. The interviewing station 12 further includes a camera stabilizing device 22 on which the components of the capture and display unit 16, the two-way wireless sound 18 and video processing apparatus 20 are all mounted and distributed in a manner which does not interfere with the function of the device 22. In particular, the camera stabilizing device 22 preferably includes a STEADICAM®, which is well known to those skilled in the art for use in dampening the effect of camera operator motion on the video images while filming.

The two-way wireless sound 18 and the two-way wireless video 20 processing apparatus allow wireless communication between the two stations 12 and 14 and facilitate the portability of the station 12. Accordingly, the interviewer can hear and see video of the subject at his remote host station 14, and the subject can hear and see video of the interviewer at the interviewing station 12. The video capture and display unit 16 is configured to allow the subject and interviewer to maintain eye-to-eye contact during the interview through the video images portrayed at the respective stations. The camera stabilizing device 22, in cooperation with the video capture and display unit 16, allows the operator to film the subject, therefore, in a first person style dialogue with the subject conversing with the interviewer while appearing to look directly into a camera lens.

The interviewer or host's face appears on the screen, allowing the subject to look directly into the camera while interacting with the interviewer. This provides a unique format for conducting a remote interview of a subject in the field as opposed to in a studio or static environment.

To obtain this personalized effect, the video capture and display unit 16 includes a camera 24 for capturing locally obtained video of the interviewee/subject and a monitor 26 for displaying live video of the remote host. The camera 24 and monitor 26 are configured and arranged to place an image of the host from the monitor 26 in front of the camera 24 with negligible effect on the locally captured video of the subject. The video capture and display unit 16 also. preferably includes a video and audio recorder 28 for recording the locally obtained video and audio of the interviewee directly from the camera 24.

An input audio signal 30 to the camera 24 for generating an output audio signal 32 to the recording device 28 is obtained from the two-way wireless sound processing apparatus 18. In particular, a sound transmitting portion 34 of the wireless sound processing apparatus 18 locally captures the interviewee's voice, as well as the host's voice heard over the speaker 48, with a microphone 36. In one preferred embodiment, the microphone 36 is a stereo microphone that is operatively electrically connected to a two-channel mixer 38, which is known to those skilled in the art for processing the left and right stereo signals. The mixer 38 produces the audio input signal 30 to the camera 24 for recording the host and subject audio, and is also operatively connected to a wireless audio transmitter 40 for wireless transmission to the remote host station 14.

The two-way wireless sound processing apparatus 18 also includes a sound receiving portion 42. The receiving portion 42 includes a wireless receiver 44 for wirelessly receiving an audio signal 46 of the host transmitted from the host station 14 and a small speaker 48 for projecting the host's voice to the interviewee.

The wireless sound receivers and transmitters of the present invention may include any such suitable devices known to those skilled in the art for use in wireless audio technology.

In addition to producing video output 50 to the recording device 28, the camera 24 also provides a video signal 52 to a wireless video transmitter 56 of the two-way wireless processing apparatus 20. An omnidirectional antenna 58 is operatively connected to the video transmitter 56 and wirelessly transmits the locally captured live video of the subject to the remote host station 14 for real-time viewing by the host.

One skilled in the art will appreciate that the video transmitter 56 modulates the video signal with preferably a radio frequency (RF) or microwave frequency for transmission by the antenna. Any known video transmitter known to those skilled in the art may be used which is suitable for operatively mounting to the portable camera stabilizing device 22 of the present invention. One skilled in the art will recognize that the wireless video transmitter 56 of the interviewing station 12 must be compatible with a video receiver in the remote host station 14.

The video processing apparatus 20 also includes a directional antenna 62 for wirelessly receiving a video signal 64 of the host from the host station 14 and a video receiver 66 for demodulating the signal 64. One skilled in the art will appreciate that the video receiver 66 may be any suitable video receiver which is compatible with a video transmitter on the remote host system 14 and is suitable for operatively mounting to the portable steadicam-operated camera system 12. The processed video signal 68 is input to the monitor 26, so that the interviewee can view live video of the host on the monitor 26.

In a preferred embodiment, the directional antenna 62 is a helical directional antenna, positioned atop the video capture and display unit 16.

The combination of the wireless features, including the directional antenns 62, as well as an appropriate distribution of various electrical elements to prevent electrical interference, allows two-way wireless video transmission, a camera, and a monitor showing live video to be mounted on and operated with a STEADICAM®. Such an arrangement, including the eye-to-eye contact provided for by the video capture and display unit, is not known in the prior art. The various components are mounted on the camera stabilizing device 22 with a proper distribution of weight that allows the interviewing system 12 to be operated with ease in the same way the operator would control a steadicam-mounted professional camera.

The remote host station 14, unlike the interviewing station 12, is not required to be operated by a third party. Rather, it can be solely operated by the host, while simultaneously conducting the interview. This part of the system 10, therefore, must be particularly easy to use, portable, and simultaneously operable while being moved to remain within an allowable distance from the interviewing system 12 and subject. The allowable distance is preferably determined by the available operating range of the wireless transmitters and receivers and not limited by electrical interference between the two pairs of transmitters and receivers required for the two-way wireless video transmission.

In a preferred embodiment, the distance between the interviewing station 12 and the remote host station 14 may be over 30 feet.

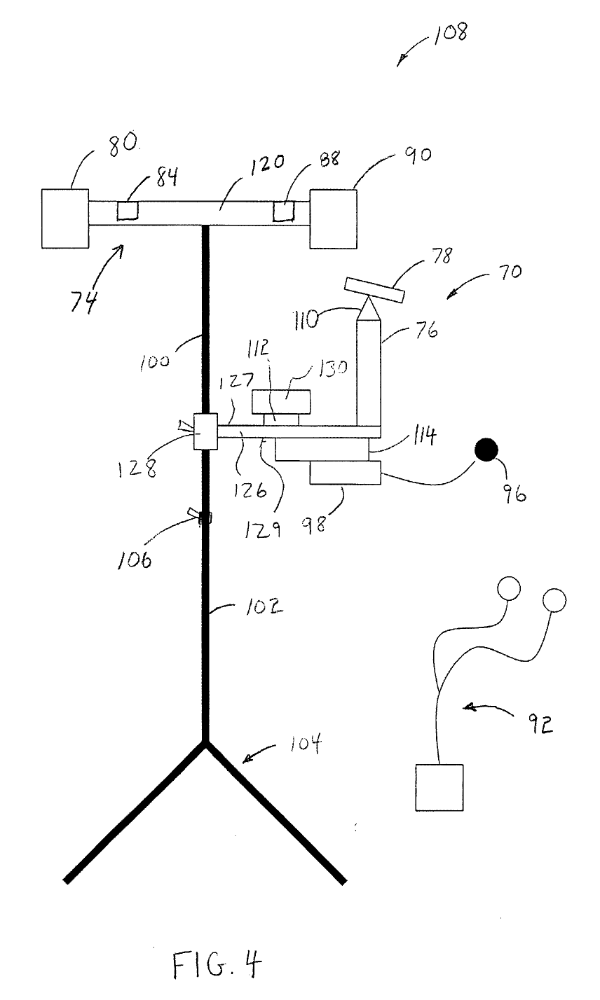

Referring still to FIG. 1, the remote host station 14 includes a compact monitor and video capture unit 70, wireless sound processing apparatus 72, and wireless video processing apparatus 74. All components of the remote host station 14 are operably mounted on a hand-carried portable telescoping pole 75, referred to herein as a “staff.” Just as the interviewed subject can see the host's face on the monitor 26, the host can see the subject on a small monitor 76 on the portable remote host station 14. The monitor and video capture unit 70 also includes a compact video camera 78, such as a Sony XC555 “cigar cam.” The camera 78 is placed directly adjacent and centered to the monitor 76, which is preferably a high brightness monitor, for example, a liquid crystal display (LCD) monitor. Preferably, the camera 78 is positioned on a tilt-adjustable mount 110 (see FIG. 4) mounted to the top of the monitor 76, and centered to the monitor's vertical axis. Therefore, the host's line of vision viewing the monitor 76 is nearly coincident with the optical axis of the camera 78 recording the host. Accordingly, due to the compact nature of the camera and monitor, the effect of the host looking directly into the camera while interacting with the subject is essentially maintained. This eliminates the typically heavy one-way reflective screen used in a teleprompter-type system to achieve the same effect, and thus allows the host's system 14 to be lightweight and portable.

In one preferred embodiment, for example, the camera 78 is a Sony XC555 cigar cam, from the Sony Corporation of America, 550 Madison Avenue, New York, N.Y. 10022 and the monitor 76 is a four-inch super bright Starlite™ monitor from Trans Video International, 11712 Moorpark St., Suite 112B, N. Hollywood, Calif. 91604. The Starlite™ monitor advantageously offers an automatic brightening feature, which automatically increases the brightness of the monitor in response to an increase in light/sunlight falling on the monitor.

The wireless video processing apparatus 74 include a directional antenna 80 for receiving a video signal 82 in order to obtain real-time video images of the interviewee. The antenna 80 is operatively electrically connected to a wireless video receiver 84 for demodulating and processing the video signal 82. The receiver 84 is in turn operatively connected to the monitor 76, on which the host views the live remote video of the subject.

The wireless video processing apparatus 74 also include a video transmitter 88 and a second directional transmitting antenna 90. The directional antenna 90, preferably a helical antenna, produces a strong helical signal in a specific direction. The camera 78 simultaneously outputs live video 86 of the host to the video transmitter 88, which modulates the signal 86 for transmission by the antenna 90 to the interviewing station 12. The subject views the live video of the host on the monitor 26.

The wireless video processing apparatus 74, therefore, include directional antennae which allow the receiver 80 and transmitter antenna 90 to be mounted close to one another on the remote host station without incurring interference between the two channels. Either microwave or radio-frequency transmission may be used.

The wireless sound processing apparatus 72 include a wireless audio receiver with integrated earphones 92. The transmitted audio signal 94 from the interviewing system 12 of the subject's voice is, therefore, heard through earphones worn by the host. The apparatus 72 also includes a microphone 96 operatively connected to a wireless audio transmitter 98 which is compatible with the audio receiver 44 in the interviewing system 12. The audio transmitter 98 thus wirelessly transmits the host's voice to the interviewing system 12.

Any of the known audio and video transmitters and receivers known to those skilled in the art and suitable for use on the portable remote host system 14 may be used.

Any directional antenna may also be used. Helical directional antennae are preferred.

The portability of the remote host station 14, which may be simultaneously hand-carried and operated by the host, provides more flexibility in conducting interviews. The integration of two-way wireless video transmission using directional antennae between the two stations 12 and 14 eliminates the need for bulky and unwieldy video cables. The portability, as well as the effectiveness of the wireless video transmission, is further enhanced by the use of the telescoping pole 75.

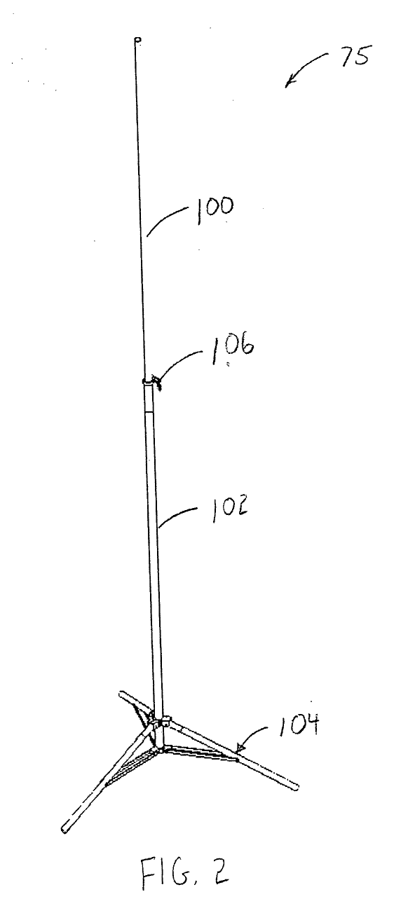

Referring to FIG. 2, a preferred embodiment of the telescoping pole or staff 75 preferably includes two portions, an upper portion 100 and a lower portion 102, and a collapsible tripod base 104. The upper portion 100 of the staff 75 can be lowered into or raised from the hollow interior of the lower portion 102 by loosening a hand releasable or quick release type of clamp 106, such as a Kipp-style hand clamp known to those skilled in the art. The clamp 106 is then preferably tightened with one half-turn once the staff 75 is adjusted to the desired height.

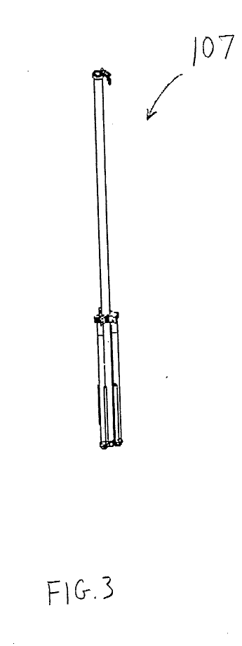

Referring to FIG. 3, the staff is shown in its most compact closed position 107 for easy portability. Once the components are mounted on the staff 75, the upper portion 100 will not be completely retractable. Nevertheless, when the base 104 is folded up, the staff 75 is easily portable and carried by the host. The base 104 is unfolded when the station 14 is to be used in one location for a reasonable period of time.

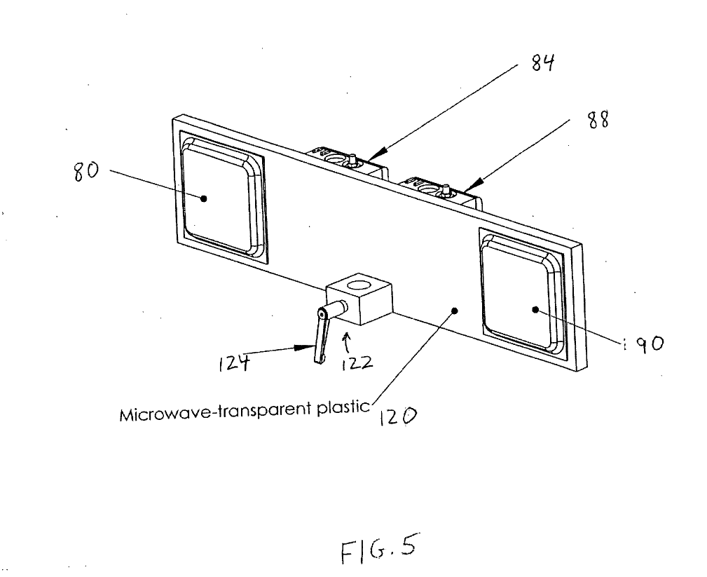

FIG. 4 is a schematic representation of an embodiment of a remote host station 108 showing a preferred arrangement of the components of the remote host station 14 shown in FIG. 1 on the staff 75. Quick release clamps, which may also be hand-operable Kipp-style clamps, are used to attach both the video processing apparatus 74 and the video capture and display unit 70. The video processing apparatus 74 including the directional antennae 80 and 90 are preferably mounted to the top of the upper telescoping portion 100 with hand-adjustable clamp 122 (see FIG. 5). The clamp 122 allows for adjusting the vertical position of the video processing apparatus 74 on the upper portion.

Referring also to FIG. 5, the clamp 122 may be hard-mounted to a mounting plate 120 using any suitable attaching means such as screws and nuts, or a durable epoxy, for example. The receiver 84 and receiving antenna 80, which are electrically connected, are preferably mounted on one end, in close proximity to one another, and on either side of the mounting plate 120. The transmitter 88 is preferably located on a same side as the receiver 84 and on an opposite side as the antenna 90 to which it is connected. As shown, transmitter 88 and antenna 90 are preferably located on an opposite end of the mount 120 away from the receiving antenna 80. The plate 120 is shaped and sized to allow enough separation between the antennae 80 and 90 to minimize interference between the two transmitter-receiver pairs or channels (formed by receiving antenna 80/transmitting antenna 58 and transmitting antenna 90/receiving antenna 62) and thus allow two-way wireless video communication.

Preferably, the wireless video receiver 84 and transmitter 88 and associated antennae 80 and 90 operate in the microwave regime. The mounting plate 120 is preferably formed of a microwave-transparent plastic.

Referring again to FIG. 4, a mounting platform 126 is also attached to the staff via another hand-adjustable quick-release clamp 128. The mounting platform 126 is adapted to attach to the clamp 128 using any suitable hardware well-known to those skilled in the art, such as a right angle bracket threadedly attached between clamp 128 and platform 126. The vertical position of the mounting platform 126 relative to the video apparatus 74 mounted to plate 120 is adjusted by loosening the clamp 128, sliding the attached platform 126 to the desired position on the staff 75, and locking the clamp in place. The vertical position of all components on the upper portion 100 is adjustable in one motion by loosening the clamp 106 and raising or lowering the upper portion 100 out of, or into, the lower portion 102, respectively.

In the embodiment shown in FIG. 4, the camera 78 is positioned on a vertical tilt-adjustable mount 110 (see FIG. 4) mounted on the top of the monitor 76, and centered to the monitor's vertical center axis. The monitor 76 is then mounted to the top surface 127 of the platform 126. The microphone 96 is a gooseneck-style microphone mounted directly to the wireless audio transmitter 98, which is mounted to the bottom surface 129 of the platform 126 and is also aligned to the vertical center of the monitor 76.

Also preferably mounted to the platform 126 are associated electronics for powering and operating all the electronic apparatus and devices on the staff 75. In one preferred embodiment shown in FIG. 4, the remote host station 108 also includes a battery 112, preferably a lithium battery, which is mounted to the upper surface 127 of the platform 126. The battery 112 preferably powers at least the monitor 76 and the camera 78, and preferably also powers the video transmitter and receiver. Some components, e.g., the audio transmitter, may include locally connected batteries as required.

The remote host station 108 also preferably includes a video switcher 114 which is mounted to the bottom surface 129. As known to those skilled in the art, the video switcher 114 distributes the video images from the camera 78 to the wireless transmitter 88 and from the wireless receiver 84 to the monitor 76. The video receiver 84 is thus connected via the switcher 114 to the input of the monitor 76 using standard video cable. The switcher 114 also routes the transmitted image of the host. The switcher 114 thus allows the host to switch between viewing the subject and his own image, which is transmitted to the portable interviewing station, on the monitor. This function of the switcher 114 allows the host to set up the camera 78 settings, e.g., exposure and brightness functions, as well as camera alignment. The switcher may also include a battery for supplying power to various components.

The video transmitters and receivers are connected to cameras and monitors respectively via standard video cable.

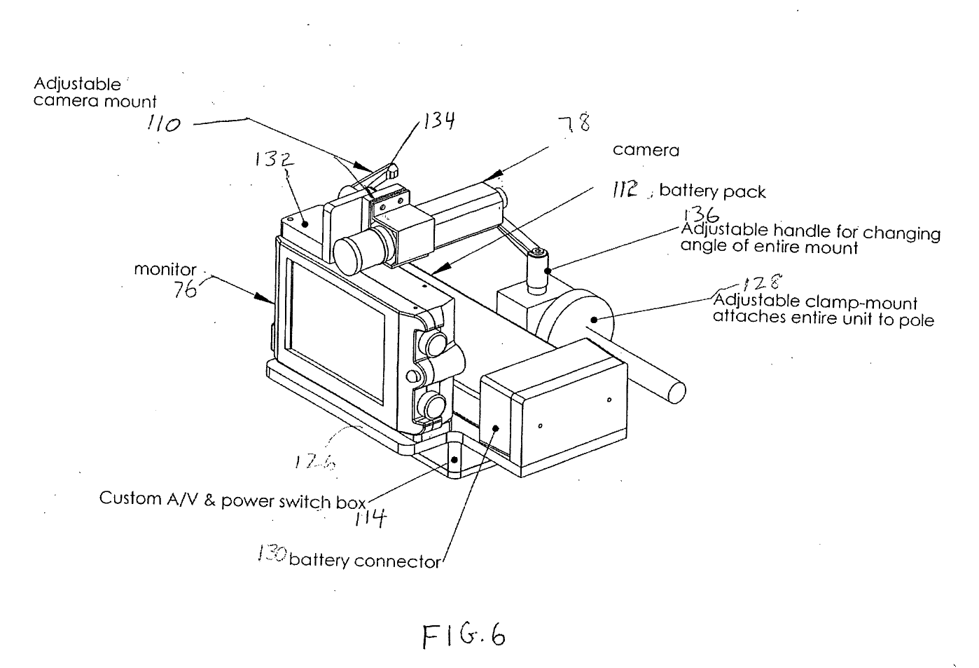

A perspective representation of the platform 126 and various mounted components is shown in FIG. 6. Referring to FIGS. 5 and 6, the battery pack 112 is connected to a connector box 130, which includes the connectors required for powering the electronics. Both are located behind the monitor 76. A right angle bracket 132 mounts the camera 78 to the top of the monitor 76 and also accommodates the tilt-adjustable mount 110 for vertical-angle adjustment of the camera 78. As shown in FIG. 6, the tilt-adjustment of the camera 78 is preferably provided using a handle 134 for hand-loosening, adjusting, and locking the angle of the camera mount 110.

Referring still to FIG. 6, an additional handle-adjustable clamp 136 with appropriate mounting hardware, may also be provided for changing the horizontal angle of the entire platform 126.

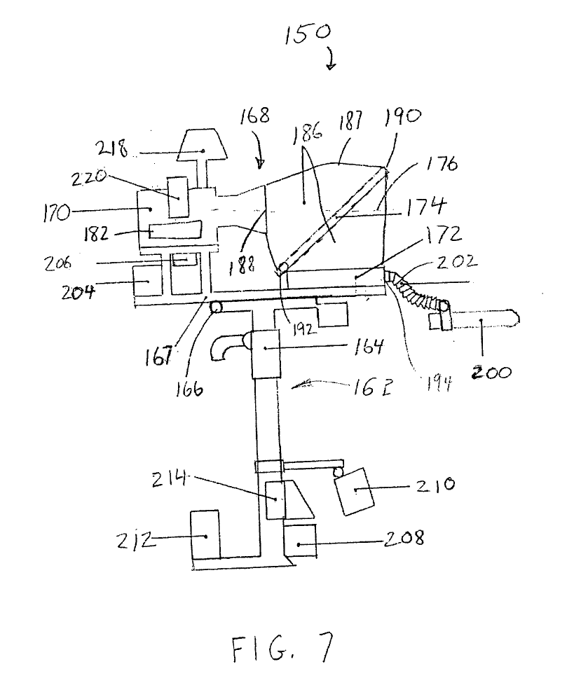

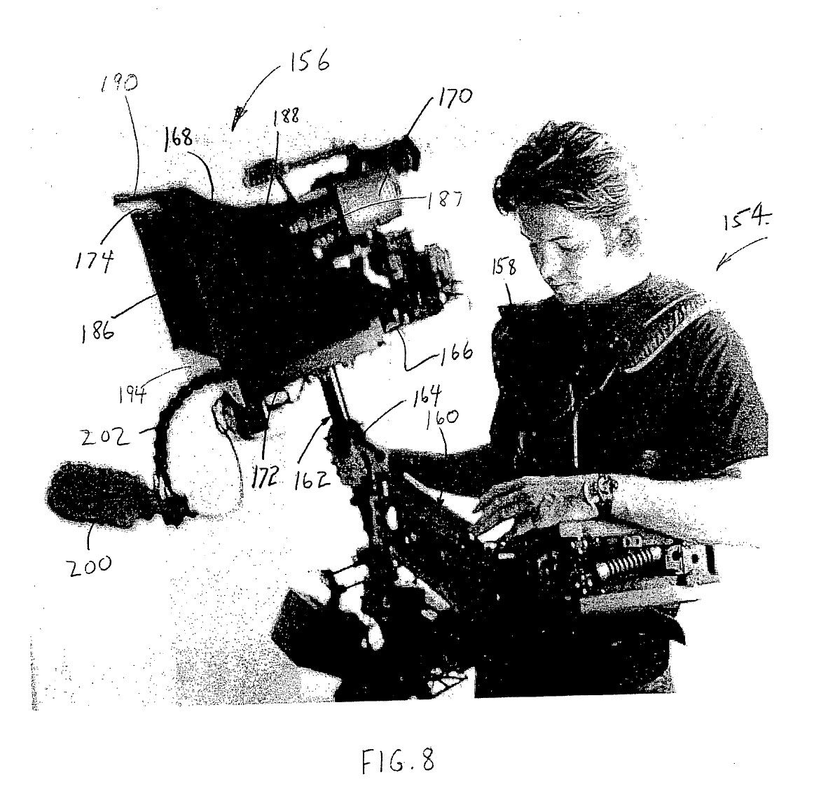

FIG. 7 is a schematic representation of an embodiment 150 of the interviewing station showing a preferred arrangement of the various components mounted on a sled 152 of a camera stabilizing device 154, e.g., on a modified STEADICAM® device, as shown in FIG. 8.

In FIG. 8, a photographic representation of a steadicam-mounted interviewing station 156 formed in accordance with the present invention, shows particular basic components of a STEADICAM® device which are included in the camera stabilizing device 154. These basic components are well-known to those skilled in the art. The device 154 includes a padded vest 158, which is strapped to a camera operator, an articulated arm 160, which is connected to the vest 158 on one end, and connected to a sled or post 162 at the other end. The terms “sled” and “post” are sometimes used in the art to differentiate between different portions of the post 162 to which the arm attaches. However, “sled” and “post” are used herein interchangeably to refer to the entire extent of the post 162.

One skilled in the art will recognize that the articulated arm 160 links the padded vest 158 on the operator's body with sensitive fingertip control of the camera movement through a hand-operated control 164. At the top of the sled 162, a top stage 166 is provided onto which a camera is directly mounted in conventional steadicam devices. The “frictionless” articulated arm movement counters the vibrational effects on the image caused by the camera operator's movement. Thus, by adapting the basic components of a STEADICAM® device, for example, a STEADICAM® EFP, for use in the camera stabilizing device 154, the camera operator has freedom of movement to film a moving subject without sacrificing video quality. Simultaneously, the subject maintains eye-to-eye contact with the host via the video capture and display unit 16 (see FIG. 1).

On a conventional STEADICAM® device, a monitor and a battery pack for powering the STEADICAM® device and the camera are mounted to the bottom part of the sled. One skilled in the art will appreciate that proper positioning of the monitor and battery pack and the camera around the point of attachment of the articulated arm to the post is required in order to properly distribute the weight of these components. The cables connecting the monitor and conventional video camera sled in a conventional STEADICAM® device are contained within the sled.

Referring again to the preferred embodiment of FIG. 7, the various electronic components of the portable interviewing station are all operably mounted on the sled 162. All components are mounted using methods and hardware well-known to those skilled in the art.

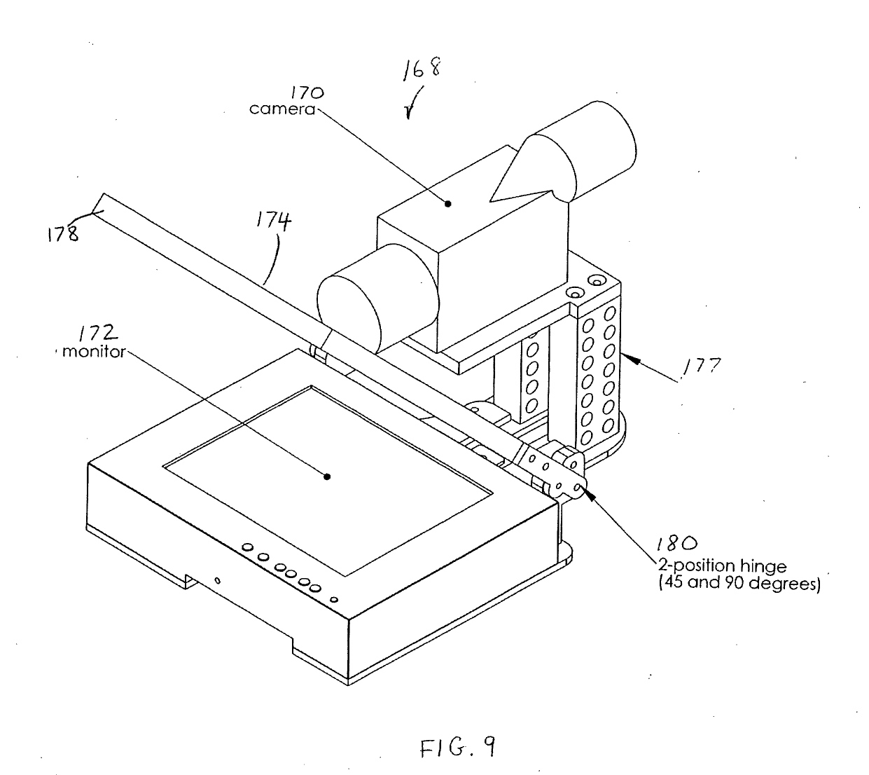

Referring also to FIG. 9, a preferred embodiment 168 of the video capture and display unit is operatively mounted to the top stage 166 via an intermediate mounting platform 167. The preferred video and display unit 168 includes a video camera 170, a monitor 172, and a partially reflecting screen 174. The image surface of the monitor 172 is positioned parallel to the optical axis of the camera 176. The screen 174 is positioned in front of the camera 170 at a forty-five degree angle to the optical axis 176. The screen 174, monitor 172 and camera 176 are relatively positioned so that the image from the monitor 172 is partially reflected into the subject's line of vision by the screen 174, in a teleprompter-type arrangement. Accordingly, an interviewee looking directly into the video camera 170 maintains eye to eye contact with an image of the remote interviewer displayed on the video monitor 172.

In one embodiment, the screen 174 is about 30% reflective and about 70% transmissive (30/70), so that the screen's effect on the image of the interviewee transmitted to the video camera 170 is negligible. The screen preferably includes thin-film coated optical glass.

As shown in FIG. 9, a vertically adjustable bracket 177 is used to properly position the camera 170 to the screen 174 and monitor 172. The screen 174 is held in place by a frame 178, which may be connected to the monitor 172 by, for example, a set of two-position hinges 180. The hinges 180 allow the frame 178 containing the screen 174 to be positioned flat against the monitor 172 when not in use, and raised to 45 degrees when operated.

In another embodiment, the frame 178 is adapted, according to any methods and using any hardware known to those skilled in the art, for easy and quick interchangeability of screens. Therefore, a 30/70 screen can be replaced by a more highly reflecting screen on a particularly bright day, for easier viewing of the transmitted video. For example, a 40% reflective/60% transmissive screen (40/60) may optionally be used.

The camera 170 may be any commercial video camera, preferably a so-called prosumer camera, which can be mounted and operated on a steadicam, and which includes standard audio input connectors for recording audio from a separate device, e.g., from a microphone. Preferably, the camera 170 is a progressive scan camera and includes an integrated recording device 182 for recording video and audio to a recording medium. The camera 170 also preferably includes a small integrated pop-up monitor, such as a liquid crystal display (LCD) monitor. The camera operator uses the pop-up monitor to keep the subject in the field of view.

In a preferred embodiment, the camera 170 is a Panasonic DVX100A Mini DV Camcorder, from Panasonic Corporation of North America, Panazip 2F-3, One Panasonic Way, Secaucus, N.J. 07094, with a mini DVD audio/video recording device and side pop-up LCD display.

The video monitor 172 is preferably a 13-inch diagonal high brightness monitor, most preferably with an automatic brightening feature that responds to bright sunlight. In the best mode, the video monitor 172 is a Boland Communications Transflective Monitor, from Boland Communications, Lake Forest, Calif.

Referring again to FIGS. 7 and 8, the preferred embodiment of the interviewing station 150 additionally includes a three-sided shroud 186 shaped to shade the monitor 172 and screen 174 from direct sunlight and therefore enhance the contrast of the video images viewed by the interviewee. The shroud 186 is preferably adapted to attach to the body of the camera 170 behind the point of attachment of the lens to the camera body, to avoid interference of zoom or other functions of the camera 170. A top surface 187 of the shroud 186 is rectangularly shaped with an aperture 188 which tightly surrounds the camera lens. The top surface 187 extends from the top edge 190 of the screen 174 to the screen/monitor interface 192. The other two surfaces are in the shape of right-triangles with the hypotenuse attached to the side edges of the top surface 187. The front edges of the top surface 187 and the side surfaces are substantially planar with the front edge 194 of the monitor 172. The shroud 186 tightly surrounds the lens aperture and the sides of the monitor 172 to minimize direct sunlight falling on the screen 174 and monitor 172.

Preferably, the shroud 186 may be formed from any lightweight, opaque material, which can be adapted to snugly fit around the camera lens and attached to the mounting platform 167 around the sides of the monitor 172 in a light-tight fashion. In a preferred embodiment, a heavy opaque fabric is used. In the best mode, the shroud 186 is formed from duveteen.

Referring again to FIG. 7, a stereo microphone 200 is preferably operably mounted to the stage 166 of the sled 162 and aligned to the optical axis 176 of the camera 170, so that the sound axis and image axis are parallel and centered. In addition, the microphone 200 is mounted so that it travels with the camera 170, and maintains the same alignment. Accordingly, no matter where the camera 170 is pointed, the microphone 200, and thus the audio, stays aligned with the video image.

In one embodiment, the microphone 200 is mounted to one end of an articulated arm 202. The other end of the arm 202 is connected to the monitor 172 and centered to the image.

The two-channel mixer 204 to which the microphone 200 is operably electrically connected for mixing and amplifying the stereo signal, and the wireless audio transmitter 206 receiving the mixed signal are preferably mounted adjacent the vertical camera mount 177. Of course, it will be appreciated by one skilled in the art that the present invention is not limited to use of a stereo microphone and that other microphones, such as a mono-microphone may be used with the present invention.

As shown in FIG. 7, the wireless audio receiver 208 and a battery-operated speaker 210 to which the receiver 208 is connected are preferably mounted to the bottom portion of the sled 162. The speaker 210 is connected to the receiver 208 by a cable, which may be external or internal to the sled 162. The speaker 210 is directed toward the subject/interviewee so that he or she can clearly hear the host.

A battery pack 212 that supplies power for operating the steadicam and other components, such as the speaker 210, is also located at the bottom of the sled 162 and appropriately positioned for proper weight distribution of components along the sled 162.

A wireless video transmitter with an integrated omnidirectional antenna 214 for sending the video of the interviewee collected by the camera 170 back to the remote host station is also located on the bottom portion of the sled 162. The video transmitter 214 is electrically connected internally to the sled 162 to the output video channel of the camera 170.

A directional antenna 218, preferably helical, is mounted atop the camera 170 for receiving the host's modulated video signal. The antenna 218 is electrically connected to the video receiver electronics 220 mounted on the vertical camera mount 177. The receiver 220 demodulates the host's modulated video signal and outputs the demodulated video signal into the monitor 172 for viewing by the interviewee.

In the best mode, the wireless video receiver 220 and wireless video transmitter 214 are a Transvideo Titan Microwave receiver and transmitter respectively. In addition, the wireless audio receiver 208 and transmitter 206 are a Lectronics wireless audio receiver and Lectronics IFB audio transmitter respectively. The speaker 210 is a Remote Audio Speakeasy Mini Speaker, from Remote Audio Products, 220 Great Circle Road, Suite 114, Nashville, Tenn. 37228-1737.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A portable interviewing system for capturing and transmitting video and audio via two-way wireless video and audio transmissions, said system comprising:
a portable interviewing station including a video capture and display unit having a video camera configured to capture locally obtained video for transmitting via a first directional antennae, and a video monitor to display received video from said first directional antennae, wherein said video monitor and said video camera are configured and arranged in said video capture and display unit to allow an interviewee looking directly into said video camera to maintain eye to eye contact with an image of a remote interviewer displayed on said video monitor; and
a remote host station including a compact monitor and video capture unit having a compact video camera configured to capture video of said interviewer for transmitting via a second directional antennae to said interviewing station, and a compact monitor to display received video of said interviewee from said second directional antennae, wherein said compact monitor and said compact video camera are configured and aligned to allow said interviewer looking directly into said compact video camera to maintain eye to eye contact with an image of said interviewee displayed on said compact monitor.

2. The portable interviewing system of claim 1, wherein said video capture and display unit includes a partially reflective screen positioned in front of said video camera to partially reflect an image from said video monitor toward said interviewee's line of vision.

3. The portable interviewing system of claim 2, wherein said partially reflective screen is positioned at approximately a forty-five degree angle in front of said video camera.

4. The portable interviewing system of claim 1, wherein said video capture and display unit includes a recording device for recording said video and audio of said interviewee from said camera.

5. The portable interviewing system of claim 1, wherein said video capture and display unit includes a microphone and mixer for obtaining two-channel audio of said interviewee and inputting a mixed audio signal into said video camera.

6. The portable interviewing system of claim 1, wherein said portable interviewing station further comprises wireless audio and video devices configured to wirelessly transmit and receive said audio and video information between said interviewee and said interviewer.

7. The portable interviewing system of claim 1, wherein said portable interviewing station further comprises a camera stabilizing system for dampening vibrations caused by motion of said video camera and thereby minimizing image degradation, wherein said video camera, said monitor, and said wireless video and audio transmitter and receiver devices are operatively mounted on said camera stabilizing system.

8. The portable interviewing system of claim 1, wherein said remote host station further comprises a wireless audio receiver device, a wireless audio transmitter device, a wireless video receiver device for receiving video, and a wireless video transmitter device for transmitting video, wherein said wireless devices are configured to wirelessly transmit audio and video of an interviewer to said interviewing station and to wirelessly receive said locally obtained video and audio of an interviewee from said interviewing station.

9. The portable interviewing system of claim 1, wherein said remote host station further comprises a portable mounting staff, wherein said compact video camera, said compact monitor, and said wireless video devices and antennae, and said wireless audio transmitter device are operatively mounted on said portable mounting staff.

10. The portable interviewing system of claim 10, wherein said portable mounting staff is a hand-carried portable mounting staff.

11. The portable interviewing system of claim 10, wherein said portable mounting staff is positioned on a retractable tripod base.

12. A method of providing a portable interviewing system comprising:
providing a portable interviewing station including a video camera configured for capturing locally obtained video for transmitting via a first directional antennae and a video monitor for displaying received video from said first directional antennae, wherein said video monitor and said video camera allow an interviewee looking directly into said video camera to maintain eye to eye contact with an image of a remote interviewer displayed on said video monitor; and
providing a remote host station including a compact video camera configured for capturing video of said interviewer for transmitting via a second directional antennae to said interviewing station, and a compact monitor for displaying received video of said interviewee from said second directional antennae, wherein said compact monitor and said compact video camera are configured and aligned to allow said interviewer looking directly into said compact video camera to maintain eye to eye contact with an image of said interviewee displayed on said compact monitor.

13. The method of claim 12, further comprising positioning a partially reflective screen in front of said video camera of said portable interviewing stations to partially reflect an image from said video monitor toward said interviewee's line of vision.

14. The method of claim 13, comprising positioning said partially reflective screen at approximately a forty-five degree angle in front of said video camera.

15. The method of claim 12, comprising recording said video and audio of said interviewee from said camera.

16. The method of claim 12, further comprising providing a microphone and mixer for obtaining two-channel audio of said interviewee and inputting a mixed audio signal into said video camera.

17. The method of claim 12, further comprising configuring wireless audio and video devices to wirelessly transmit and receive said audio and video information between said interviewee and said interviewer.

18. The method of claim 12, further comprising dampening vibrations caused by motion of said video camera.

19. The method of claim 18, wherein dampening said vibrations comprises mounting said video camera, said monitor, and said wireless video and audio transmitter and receiver devices to a camera stabilizing system.

20. The method of claim 12, wherein providing said remote host station comprises providing a wireless audio receiver device, a wireless audio transmitter device, a wireless video receiver device for receiving video, and a wireless video transmitter device for transmitting video, wherein said wireless devices are configured to wirelessly transmit audio and video of an interviewer to said interviewing station and to wirelessly receive said locally obtained video and audio of an interviewee from said interviewing station.

21. The method of claim 12, wherein providing said remote host station further comprises providing a portable mounting staff, wherein said compact video camera, said compact monitor, and said wireless video devices and antennae, and said wireless audio transmitter device are operatively mounted on said portable mounting staff.

22. A portable interviewing system, comprising a portable interviewing station for capturing and transmitting video and audio of an interviewee to a remote interviewer and a portable remote host station for capturing and transmitting video and audio of a remote interviewer, thereby providing live two-way wireless audio and video communication between said portable interviewing station and said portable remote host station, wherein
said interviewing station comprises:
wireless video devices including directional antennae and wireless audio devices configured to wirelessly transmit locally obtained video and audio of an interviewee to said remote host station and to wirelessly receive said video and audio of interviewer from said remote host station;
a video capture and display unit comprising a video camera configured to capture said locally obtained video of an interviewee for transmitting, and a video monitor to display the received video and audio of a remote interviewer to an interviewee, wherein said video monitor and said video camera are configured and arranged in said video capture and display unit to allow an interviewee looking directly into said video camera to maintain eye to eye contact with an image of a remote interviewer displayed on said video monitor; and
a camera stabilizing system for dampening vibrations caused by motion of said video camera and thereby minimizing image degradation, wherein said video camera, said monitor, and said wireless video and audio transmitter and receiver devices are operatively mounted on said camera stabilizing system; and wherein
said remote host station comprises:
a wireless audio receiver device, a wireless audio transmitter device, a wireless video receiver device and a directional antenna for receiving video, and a wireless video transmitter device and a directional antenna for transmitting video, wherein said wireless devices are configured to wirelessly transmit audio and video of an interviewer to said interviewing station and to wirelessly receive said locally obtained video and audio of an interviewee from said interviewing station;
a compact monitor and video capture unit comprising a compact video camera configured to capture video of an interviewer for transmitting to said interviewing station, and a compact monitor to display the received video and audio of an interviewee, wherein said compact monitor and said compact video camera are configured and aligned to allow an interviewer looking directly into said compact video camera to maintain eye to eye contact with an image of an interviewee displayed on said compact monitor; and
a hand-carried portable mounting staff, wherein said compact video camera, said compact monitor, and said wireless video devices and antennae, and said wireless audio transmitter device are operatively mounted on said portable mounting staff.
